(19) United States
(12) Patent Application Publication
(10) Pub. No.: US 2026/0191231 A1
(43) Pub. Date: Jul. 9, 2026

(54) Organic Mushroom Blend for Enhanced Animal Health and Wellness

(71) Applicants: Stephen Munive, Fort Lauderdale, FL (US); Leo Roux, Fort Lauderdale, FL (US)

(72) Inventors: Stephen Munive, Fort Lauderdale, FL (US); Leo Roux, Fort Lauderdale, FL (US)

(21) Appl. No.: 19/011,176

(22) Filed: Jan. 6, 2025

(51) Int. Cl. A23K 10/30; A23K 40/10

(52) U.S. Cl. CPC A23K 10/30; A23K 40/10

(57) ABSTRACT

An animal supplement includes a blend of Turkey Tail, Reishi, Shiitake, Chaga, Lion's Mane, Maitake, Cordyceps, and Agaricus Blazei with one of the following: Enoki, Snow Fungus, and Pori. The blend may support various immune function, cognitive health, skin health, and digestive health in animals.

### BACKGROUND OF THE INVENTION

The quest for holistic and natural remedies for improving the health and well-being of domestic animals has been an ongoing endeavor within both the professional veterinary community and among pet owners. In recent years, there has been a growing interest in the application of functional foods and nutraceuticals for pets, akin to trends observed in human nutrition and alternative medicine. Advances in research and an increased understanding of the specific nutritional requirements and metabolic idiosyncrasies of dogs and cats have facilitated the development of tailored mushroom-based supplements designed to meet these needs. As a result, pet owners are increasingly seeking such natural therapeutic options to maintain their companion animals' health and potentially mitigate the impact of various health issues associated with aging and environmental stressors.

### SUMMARY OF THE INVENTION

In one aspect, an enhanced organic mushroom animal supplement for canines and cats involves mixing a variety of organic therapeutic fungi including organic Turkey Tail, Shiitake, Reishi, Lion's Mane, Maitake, Agaricus Blazei, Cordyceps, and Chaga. The supplement also includes Enoki (Flammulina velutipes), Snow Fungus (Tremelia fuciformis), and/or Poria (Wolfiporia extensa).

The enhanced organic mushroom animal supplement tailored for canines may present various advantages which can contribute to the overall health and wellness of pet dogs. For example, the supplement provides various positive health outcomes including enhanced immune function, improved gut health, and increased resilience to stress and disease. Other advantages may include, but are not limited to, the following:
Broad-Spectrum Benefits: The diverse array of medicinal mushrooms selected for the supplement—such as Turkey Tail, Shiitake, Reishi, Lion's Mane, Maitake, Agaricus Blazei, Cordyceps, Chaga, and Enoki—provides a wide range of bioactive compounds. This broad-spectrum approach ensures the activation of multiple pathways within the canine body to support overall health holistically.

Immune System Support: In particular, mushrooms like Turkey Tail and Reishi are renowned for their immunomodulatory effects. They contain beta-glucans and other polysaccharides that can enhance the immune response, potentially helping dogs fight off infections and improve their immune system resilience.

Digestive Health Improvement: Certain mushrooms in the supplement (e.g., Shiitake and Lion's Mane) are known to contain prebiotic fibers that support a healthy gut microbiome. This can aid in digestion and the absorption of nutrients, which is key to maintaining the health of domestic animals.

Anti-Inflammatory and Antioxidant Properties: The inclusion of mushrooms such as Chaga and Cordyceps contribute powerful anti-inflammatory and antioxidant properties. This may aid in reducing oxidative stress and inflammation-related issues that can lead to chronic diseases in dogs.

Enhanced Vitality and Energy Levels: Cordyceps, in particular, is famed for its energy-boosting properties. By incorporating this mushroom into the supplement, it may help to enhance the physical performance and vitality of canines, keeping them active and energetic.

Cognitive and Nerve Support: Lion's Mane is a mushroom with the ability to support nerve growth and cognitive function. This could be particularly beneficial for aging dogs or those with nerve-related issues.

Skin and Coat Health: The antioxidants and vitamins present in medicinal mushrooms can promote healthy skin and a glossy coat in animals, thereby improving their appearance and potentially reducing the incidence of skin diseases.

Cancer-Fighting Potential: Some mushrooms, such as Turkey Tail and Maitake, have been studied for their potential anti-cancer properties. While not a substitute for veterinary cancer treatments, the supplement could serve as a complementary approach to boosting the overall health of dogs undergoing such therapies.

Natural and Organic: By emphasizing organic mushroom sources, the supplement avoids the inclusion of synthetic additives, pesticides, or herbicides, aligning with pet owners'preference for clean, natural products for their companions.

Tailored for Canines: Recognizing the nutritional requirements of dogs, the supplement is specifically designed to be safe and efficacious for canine metabolism, ensuring appropriate dosages and ingredient profiles suitable for dogs of various sizes and breeds.

Convenience: The supplement offers a user-friendly alternative to preparing individual mushrooms, simplifying the inclusion of these beneficial fungi in a dog's diet and ensuring pet owners can conveniently provide these health benefits to their pets.

These advantages, among others, lend the enhanced organic mushroom supplement the potential to significantly contribute to the preventive healthcare regimen for canines, aiming to improve their quality of life and potentially extend their longevity.

### BRIEF DESCRIPTION OF DRAWINGS

FIG. 1 shows an exemplary process to form an animal feed supplement.

### DETAILED DESCRIPTION OF THE INVENTION

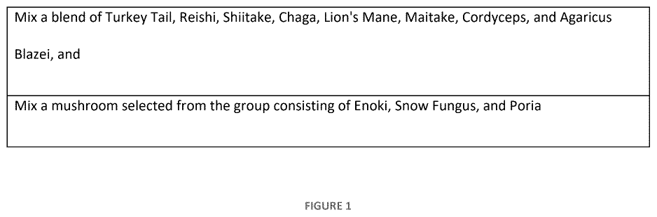

FIG. 1 shows a process to fabricate an enhanced organic mushroom supplement for canines. The process involves mixing a variety of organic therapeutic fungi including organic Turkey Tail, Shiitake, Reishi, Lion's Mane, Maitake, Agaricus Blazei, Cordyceps, and Chaga. The supplement also includes Enoki (Flammulina velutipes),Snow Fungus (Tremelia fuciformis), and/or Poria (Wolfiporia extensa).

In one implementation, the percentages by weight are as follows:
a. Turkey Tail Mushroom—34%
b. Shiitake Mushroom—15%
c. Reishi Mushroom—13%
d. Lions Mane Mushroom—9%
e. Maitake Mushroom—8%
f. Agaricus Blazei/Almond Mushroom—6%
g. Cordyceps Mushroom—6%
h. Snow Fungus Mushroom—5%
i. Chaga Sclerotium Mushroom—4%

Variations can include adding (to reach a total of ingredients of 10 or 11 mushrooms):
a. Enoki Mushroom: 2-6%
b. Poria Mushroom: 2-6%
Variations can also include replacing Snow Fungus by Enoki and/or Poria in the 2-6% range.

Another formulation includes the following proportion by weight:
a. Turkey Tail Mushroom—34%
b. Shiitake Mushroom—15%
c. Reishi Mushroom—13%
d. Chaga Sclerotium—9%
e. Lions Mane Mushroom—9%
f. Maitake Mushroom—8%
g. Agaricus Blazei/Almond Mushroom—6%
Cordyceps Mushroom—6% Turkey Tail Supports immune function and may help reduce lumps and bumps. Reishi Boosts the immune system and helps manage skin conditions. Shiitake contains lentinan, which supports immune defense against irregular cell growth. Chaga promotes smooth skin and a healthy coat while potentially slowing cancer cell formation. Lion's Mane supports cognitive health and skin vitality. Maitake Activates immune cells, assisting in combating abnormal cell formation. Cordyceps increases energy and helps prevent growth of mutated cells. Agaricus Blazei stimulates the immune system to address abnormal cell growth.

To the above mixture, the supplement includes Enoki (Flammulina velutipes). Enoki has immune-boosting beta-glucans and is associated with tumor-inhibiting properties, providing a broader immune defense for pets. Enoki contains polysaccharides like beta-glucans, which are known to enhance immune system function by stimulating macrophages and other immune cells. This could complement other mushrooms in the blend like Reishi or Turkey Tail. Enoki has antitumor and cytotoxic effects, which can help in managing abnormal cell growth or preventing it from escalating. Its antioxidant content helps combat oxidative stress, a common factor in aging and inflammatory conditions. Enoki supports gut

health due to its prebiotic fibers, which promote healthy gut flora, indirectly boosting immunity

and nutrient absorption. Enoki has compounds that may reduce inflammation, making it beneficial for dogs with chronic inflammatory conditions.

Snow Fungus (Tremella fuciformis): Tremella is well-regarded for skin hydration and regeneration, enhancing the product's benefits for skin and coat health. Snow Fungus is known for its powerful hydrating properties, attributed to its polysaccharides, which can help retain moisture in tissues. This supports skin elasticity and hydration, making it an excellent choice for dogs prone to dry or irritated skin. It contains

antioxidants that combat oxidative stress, a contributing factor in aging and inflammatory conditions. This may enhance overall health and reduce chronic inflammation. Like other mushrooms, Snow Fungus contains beta-glucans, which modulate immune responses, potentially improving resistance to infections or disease. Its compounds can help reduce inflammation, making it beneficial for dogs with conditions like arthritis or chronic skin issues. The hydrating and regenerative properties of Snow Fungus may promote faster recovery from wounds or skin irritations.

Poria (Wolfiporia extensa): Poria has adaptogenic properties, Poria helps modulate immune responses and supports gastrointestinal health, which could enhance the product's scope for pets with digestive or stress-related issues. Poria is often used to improve digestion and alleviate gastrointestinal

issues, including bloating, diarrhea, and poor nutrient absorption. It works by regulating fluids in

the digestive system. Like many medicinal mushrooms, Poria contains polysaccharides that help

modulate the immune system, strengthening overall immunity while preventing overactive

responses like allergies. Poria is known for its mild sedative properties, which can help reduce

stress and anxiety in dogs. This makes it particularly useful for pets with stress-related immune

suppression or digestive issues. This may need to be considered as there are some pets that

already report a type of stupor or lethargy with our current blend. The mushroom has

compounds that reduce inflammation, helping manage chronic conditions such as arthritis or

skin irritations. Poria is traditionally used to support kidney health and balance fluids in the body, which could be beneficial for dogs prone to kidney or urinary tract issues. This mushroom is a diuretic and may increase the diuretic effect of the current blend.

The use of Enoki, Snow Fungus, or Poria adds new dimensions—hydration, microbiome modulation, and adaptogenic stress relief and creates a synergistic, multi-functional blend. The above powder blend has shown a much faster/larger response than any single mushroom offers. This mushroom blend is designed to support immunity, reduce inflammation, and promote longevity redefines how veterinarians approach pet wellness. The power can be mixed with food and administered daily. For mini-dogs, one-quarter teaspoon or 0.5 grams can be mixed per 25 lbs dog weight. For small dogs (26-50 libs weight), ½ teaspoon can be used daily. For medium dogs (51-75 lbs), ¾ teaspoon can be used daily, and large dogs (over 75 lbs), one teaspoon can be used daily. For cats, ⅛ teaspoon (0.25 grams) of powder can be mixed with cat food. For improved results, the dosage can be doubled for the first 7 days. The power can be sprinkled and mixed with water to dry food.

The Specific mushroom components medicinal mushrooms work together to boost the immune system by using various biological pathways. This ensures thorough immune protection and overall health support.

The supplement enhances cognitive health, especially in aging dogs, by using natural compounds that support brain function. This addresses cognitive decline as part of its multi-faceted health benefits.

Specific mushroom components work together to enhance skin hydration and strengthen resilience. They also help manage various skin conditions effectively. The supplement is designed to enhance gut health by including prebiotic mushrooms. These mushrooms support the growth of beneficial gut bacteria.

The supplement includes adaptogenic components aimed at relieving stress in dogs. These elements contribute to their overall well-being and health.

The supplement is available in different forms for dogs, such as powders, liquids, chews, or capsules. This variety ensures easy and convenient administration to suit different preferences and needs.

One implementation involves using a blend of medicinal mushrooms to create a canine health supplement. This supplement is designed to offer holistic health benefits and serve as a form of preventive healthcare for dogs.

Turkey Tail is renowned for its immune-boosting properties, given its rich content in polysaccharopeptides. Reishi, often known as the “mushroom of immortality,” aids in stress management and supports immune function while offering benefits for skin conditions due to its triterpene content. Shiitake contains lentinan, a compound known to support immune defense against irregular cell growth and enhance vitality. Its richness in beta-glucans aids in stimulating various immune cells, enhancing defense against pathogens. Chaga is included for its ability to promote a healthy skin and coat, attributed to its high antioxidant content that may potentially inhibit cancer cell formation. Lion's Mane is incorporated to support cognitive health, particularly in aging animals, by promoting nerve growth factor production essential for maintaining healthy brain function. Maitake is valued for activating immune cells and assisting in combating abnormal cell formation through its polysaccharides that enhance innate and adaptive immunity. Cordyceps functions by increasing energy levels and preventing the growth of mutated cells through enhanced ATP production, which improves stamina and endurance. Agaricus Blazei stimulates the immune system to counter abnormal cell growth, leveraging its beta-glucan content to enhance both innate and adaptive immunity. Enoki is chosen for its immune-boosting and tumor-inhibiting properties. As a source of prebiotic fibers, Enoki supports gut health by promoting healthy gut flora, enhancing nutrient absorption, and providing anti-inflammatory benefits.

Snow Fungus offers powerful hydrating properties, enhancing skin hydration and regeneration through its polysaccharides that exhibit strong water-binding capacity, promoting tissue repair and improving skin elasticity. Poria, known for its adaptogenic properties, is included to help modulate immune responses and support gastrointestinal health by regulating fluid balance in the digestive system while providing mild sedative effects to reduce stress and anxiety.

The synergistic effect of these mushrooms ensures a multi-functional supplement that comprehensively enhances immune function, supports cognitive health with ingredients like Lion's Mane, promotes improved skin and coat health through the combined effects of Snow Fungus and Reishi, and fosters gut health with Enoki's prebiotic fibers. Additionally, Poria's adaptogenic properties contribute to stress management, significantly affecting overall animal health. This combination creates a holistic approach to animal wellness, aligning with the increasing demand for natural, preventive health solutions in veterinary care.

In the formulation of the supplement, Organic Turkey Tail is present in the highest concentration by weight among the medicinal mushrooms included in the blend. This strategic emphasis on Turkey Tail is due to its potent immune-enhancing properties, which are primarily attributed to its rich content of polysaccharopeptides. These compounds are known to significantly bolster the immune system by stimulating the production and activity of immune cells critical for maintaining a robust immune response, such as macrophages and natural killer cells. By incorporating Organic Turkey Tail in the highest concentration, the supplement maximizes its efficacy in enhancing immune function, thereby providing a foundational health benefit that supports overall vitality in dogs. The high concentration of Turkey Tail also complements and enhances the effects of the other medicinal mushrooms in the blend, creating a synergistic formulation that targets multiple facets of canine health, including immune support, cognitive health, skin and coat vitality, and stress reduction. The careful balance and high ratio of Turkey Tail in the supplement underscore the commitment to delivering a comprehensive and effective natural health solution for canine companions.

The composition includes Organic Chaga, which maximizes antioxidant content, promoting healthy skin and coat while potentially impeding cancer cell formation. The high concentration of melanin and other compounds within Chaga plays a critical role in combating oxidative stress and reducing inflammation, thereby supporting overall canine health. With Chaga, the supplement can deliver a robust defense against free radicals, enhancing both the immune system and the vitality of the dog's skin and coat. The precise percentage ensures an optimal balance within the blend, leveraging Chaga's properties to its fullest potential while maintaining synergy with other mushroom components in the formulation.

Enoki is recognized for its immune-boosting beta-glucans, which play an essential role in stimulating the dog's natural immune response, thereby providing robust protection against infections and diseases. In addition to its immune-modulating capabilities, Enoki contains prebiotic fibers that foster the growth of beneficial gut bacteria. This prebiotic effect is vital for maintaining a healthy digestive system, improving nutrient absorption, and enhancing overall gastrointestinal health in dogs. By establishing a favorable environment for gut flora, the Enoki content contributes to the prevention and alleviation of digestive issues, offering comprehensive intestinal support. Furthermore, the inclusion of Organic Enoki enriches the blend with additional antioxidant properties, contributing to the reduction of oxidative stress and inflammation, factors often associated with chronic health conditions in dogs. The inclusion of Organic Enoki not only boosts the nutritional value of the blend but also supports the stability and shelf-life of the product by mitigating oxidation processes. Additionally, the use of organically sourced Enoki ensures that the composition remains free from pesticides and harmful chemicals, aligning with health-conscious and environmentally-friendly practices. The Enoki is added in precise proportions to maintain the balance and effectiveness of the other components, ensuring that the desired antioxidant effects are achieved without compromising the inherent qualities of the blend. By maintaining an optimal level of beta-glucans, the blend ensures that the dogs receive effective immunomodulatory benefits, contributing to enhanced resistance against pathogens and potential health disorders.

In one embodiment, the blend may be formulated to include natural anti-inflammatory ingredients such as omega-3 fatty acids, which can be derived from fish oil or flaxseed oil, and curcumin extract from turmeric. The inclusion of curcumin adds additional therapeutic benefits by targeting inflammation pathways and providing antioxidant support. These ingredients are integrated into the starch-based polymer matrix during the manufacturing process, ensuring that they are evenly distributed throughout the powder. This allows for gradual release as the animal chews, maximizing the potential anti-inflammatory effects. Additionally, the formulation ensures that these additives do not compromise the structural integrity or edibility of the toy, maintaining its attractiveness and safety for the animal. The blend also includes stabilizers and emulsifiers to enhance the consistency and shelf life of the toy, ensuring that the active ingredients remain effective over time. This dual-purpose approach not only offers an enjoyable chewing experience for the animal but also contributes to their overall well-being by incorporating health-promoting elements into a conventional pet product.

The blend may optionally specifically formulated to support cognitive function in dogs by incorporating a combination of ingredients known to benefit brain health. This formulation includes essential fatty acids such as DHA and EPA, which are derived from fish oil and are recognized for their ability to support neural development and cognitive function. Additionally, antioxidants like vitamin E, vitamin C, and selenium are included to combat oxidative stress and support brain health by neutralizing free radicals. The blend also features B vitamins, including B6, B12, and folic acid, which are crucial for maintaining healthy brain function and supporting neurotransmitter production. Amino acids such as L-carnitine and taurine are included to support neurotransmitter activity and cognitive performance. Herbal extracts like ginkgo biloba and rosemary are incorporated for their potential to enhance memory and attention. The inclusion of phosphatidylserine, a phospholipid component of cell membranes, is intended to support cognitive function by promoting neuronal communication. This carefully balanced blend is designed to provide comprehensive support for maintaining and improving cognitive health in dogs, promoting alertness, learning, and a healthy response to aging-related cognitive decline. These components work synergistically to offer a holistic approach to cognitive support in canine companions.

The medicinal mushrooms within the composition are processed into a powder form through methods of drying and grinding. This specific processing ensures the preservation of active compounds and maximizes their bioavailability in canine dietary applications. By utilizing drying techniques, the moisture content of the mushrooms is substantially reduced, which aids in maintaining the integrity and stability of the bioactive constituents. The grinding process converts the dried mushrooms into a fine powder, facilitating easy incorporation into various delivery forms such as powders, liquids, chews, or encapsulated supplements. This powder form not only retains the beneficial properties of the mushrooms but also allows for uniform distribution and consistent dosage in canine diets. The precise processing of these mushrooms is crucial for enhancing the effectiveness of the supplement, ensuring that the therapeutic benefits are efficiently delivered for optimal immune function, skin health, cognitive improvement, digestive support, and stress reduction in dogs.

One implementation relates to a dietary supplement called Buddy Guard which is formulated to be seamlessly incorporated into animal food, providing essential health benefits through a natural, organic mushroom blend. This blend is specifically designed to enhance canine health by offering a convenient and efficient way of delivering vital nutrients by mixing with regular dog food. The inclusion of the Buddy Guard into an animal's diet ensures that the supplement is easily consumed, improving adherence to the wellness regimen. The process of design and composition allows for the effortless blending of the supplement into wet or dry dog food without altering the food's inherent taste or texture, making it palatable and appealing to a variety of canine preferences and dietary needs. This method of delivery optimizes nutrient absorption and supports consistent intake, thereby maximizing the therapeutic effects of the medicinal mushrooms present in the formulation.

A feeding spoon is calibrated to administer the recommended dosage effectively, which is ¼ teaspoon (0.5 grams) of the blend for every 25 lbs of dog body weight. This aspect is particularly beneficial for maintaining consistency in dosage, ensuring that each dog receives the appropriate amount of nutrients as per the formulation's guidelines. The administering of ¼ teaspoon of the formulation for every 25 pounds of the animal's body weight provides a balanced distribution of the active ingredients in correlation with the animal's size. This dosage recommendation is designed to maximize the health benefits imparted by the medicinal mushroom blend without overwhelming the animal's system. It allows for adaptive administration based on varying weight classes among dogs, ensuring that each animal receives an appropriate and effective amount of the supplement. By tailoring the dosage to the animal's weight, the formulation ensures consistent therapeutic outcomes across different breeds and sizes, thereby facilitating a customized approach to pet health care. This specific dosage is also convenient for pet owners to manage, promoting ease of use while maintaining the formulation's intended health benefits.

The terms and expressions employed herein are used as terms and expressions of description and not of limitation, and there is no intention, in the use of such terms and expressions, of excluding any equivalents of the features shown and described or portions thereof. In addition, having described certain implementations of the technology disclosed, it will be apparent to those of ordinary skill in the art that other implementations incorporating the concepts disclosed herein can be used without departing from the spirit and scope of the technology disclosed. Accordingly, the described implementations are to be considered in all respects as only illustrative and not restrictive.

1. An animal supplement, comprising a blend of Turkey Tail, Reishi, Shiitake, Chaga, Lion's Mane, Maitake, Cordyceps, and Agaricus Blazei, with at least one of the following: Enoki, Snow Fungus, and Poria.

2. The animal supplement of claim 1, wherein the mushrooms are processed into a powder form through drying and grinding.

3. The animal supplement of claim 1, wherein the blend is formulated to be mixed with animal food.

4. The animal supplement of claim 1, comprising providing ¼ teaspoon of the supplement per 25 lbs of animal body weight.

5. The animal supplement of claim 1, wherein the blend is mixed with food.

6. The animal supplement of claim 1, wherein the blend supports immune function, cognitive health, skin health, and digestive health in animals.

7. An animal supplement, comprising a blend by weight of: Turkey Tail Mushroom at 34%, Shiitake Mushroom at 15%, Reishi Mushroom at 13%, Lions Mane Mushroom at 9%, Maitake Mushroom at 8%, Agaricus Blazei/ Almond Mushroom at 6%, Cordyceps Mushroom at 5%, and Chaga Sclerotium Mushroom at 4%.

8. The animal supplement of claim 7, comprising 2-6% by weight of Enoki.

9. The animal supplement of claim 7, comprising forming the powers in a shape.

10. The animal supplement of claim 7, comprising 2-6% by weight of Poria.

11. The animal supplement of claim 7, wherein the blend is formulated to be mixed with animal food.

12. The animal supplement of claim 7, comprising providing ¼ teaspoon of the supplement per 25 lbs of animal body weight.

13. A method to provide animal supplement, comprising: blending Turkey Tail, Reishi, Shiitake, Chaga, Lion's Mane, Maitake, Cordyceps, Agaricus Blazei, and mixing Snow Fungus thereto.

14. The method of claim 13, comprising forming a powder by drying and grinding the blend.

15. The method of claim 14, comprising mixing the powder with animal food.

16. The method of claim 13, comprising providing ¼ teaspoon of the supplement per 25 lbs of animal body weight.

17. The method of claim 13, comprising mixing the supplement with food.

18. The method of claim 13, wherein the blending comprising mixing 34% by weight of Turkey Tail, 13% by weight of Reishi, 15% by weight of Shiitake, 9% by weight of Chaga Sclerotium, 9% by weight of Lion's Mane, 8% by weight of Maitake, 6% by weight of Cordyceps, and 6% by weight of Agaricus Blazei.

19. The method of claim 13, comprising blending an additional mushroom selected from the group consisting of Enoki, Snow Fungus, and Poria.

20. The method of claim 19, comprising blending 2-6% by weight of Enoki, 5% by weight of Snow Fungus, or 2-6% by weight of Poria.
